(19) United States
(12) Patent Application Publication
(10) Pub. No.: US 2012/0213559 A1
(43) Pub. Date: Aug. 23, 2012

(54) Dual-Axis Belt Steering

(75) Inventor: Martin Krucinski, Webster, NY (US)

(73) Assignee: XEROX CORPORATION, Norwalk, CT (US)

(21) Appl. No.: 13/031,153

(22) Filed: Feb. 18, 2011

(51) Int. Cl. G03G 15/01

(52) U.S. Cl. 399/302

(57) ABSTRACT

According to aspects described herein, there is disclosed an apparatus and method for steering a belt in an image transfer assembly. The apparatus includes a image-bearing belt, at least two image transfer nips and at least two belt steering rollers. The image-bearing belt receives portions of image-forming marking material, wherein the image-bearing belt is supported by rollers. The image-bearing belt moves in a process direction for conveying the received portions of the image-forming marking material. The at least two image transfer nips transfer at least one portion of the image-forming marking material to the image-bearing belt, wherein the image-bearing belt extends continuously between the at least two image transfer nips. The belt steering rollers being disposed remote from each other along the process direction of the image-bearing belt, wherein the belt steering rollers include idler rollers directly engaging the image-bearing belt.

### TECHNICAL FIELD

The presently disclosed technologies are directed to controlling and/or improving image registration in a printing system. In particular, it is directed to an apparatus and method for steering a image-bearing belt in an image transfer assembly.

### BACKGROUND

In general, conventional image forming apparatus such as copiers and laser printers employing an electrophotographic system or electrostatic recording system have a configuration in which image exposure is performed on a surface of a photosensitive surface to form an electrostatic latent image; the electrostatic latent image formed on the surface is developed by a developing device to form a one or more regions containing image-forming marking material. One common image-forming marking material is a toner image in a predetermined color, and the toner image is directly transferred on to and fixed on a substrate sheet or temporarily transferred to an intermediate image-bearing member and is thereafter transferred to a substrate. The image-forming marking material engages and/or interacts with the belt or sheet in an image transfer zone, such as in a transfer nip. Transfer of the image to the sheet or image-bearing member should be in precise registration, otherwise it can cause processing interruptions or delays and/or impair the print quality.

Often, the image-forming marking material is built-up in stages by having the sheet or intermediate image-bearing member pass through more than one transfer nip. For example, in a “highlight color” printing apparatus, where it desired to print black plus one other predetermined color, a typical arrangement is to have a black development unit transfer its portion of the image at one stage through a transfer nip and one or more other development units (one for each of a selectable set of highlight colors, only one of which would be used) to transfer its portion of the image at another stage through a separate transfer nip. In the case of a full-color printing apparatus, there are typically four development units; cyan, magenta, yellow, and black (CMYK) and thus four transfers in order to create a full-color image. Other types of architecture include “hexachrome,” where there are two additional color development units beyond CMYK, thus providing an extended color gamut for the printer; and arrangements that include a development unit for applying clear toner, or one applying a toner with special properties such as MICR (magnetic ink character recognition) toner.

The development units can be arranged around a single photoreceptor belt; each development unit can be associated with a single drum photoreceptor, and the drum photoreceptors arranged around a common “intermediate image-bearing member” that accumulates the primary-color toner images for transfer to a print sheet; or the drum photoreceptors can each directly transfer their primary-color images to a sheet moving past each photoreceptor.

Contemporary systems assume a constant and smooth motion of the intermediate image-bearing member or the sheet carried by a sheet image-bearing member, as the belt travels through the transfer nip. If the belt drifts or creeps laterally, it can change the orientation and position of the sheet carried thereon or the image delivered into the transfer nip. Thus, lateral alignment of the belt is critical to ensure proper image-on-print medium (IOP) registration and proper color-to-color registration.

In an attempt to achieve lateral belt alignment, many printing devices incorporate a belt steering system (also referred to as a belt positioning system, a belt position tracking and correction system, etc.) to reduce deviation of the belt from its desired transport path. Various types of belt steering systems are known in the art. Typically, such belt steering systems use a single steering roller with a tilt mechanism that corrects the lateral position of the ITB, as measured by a belt edge sensor located, for example, adjacent to (i.e., near) the steering roller. Unfortunately, since such belt steering systems make corrections at only one location around the belt circumference, they are not sufficient to maintain the lateral alignment of the belt as it passes through multiple imaging transfer nips. The resulting positioning errors of the belt between the different imaging stations can result in IOP registration errors and color-to-color registration errors.

Accordingly, it would be desirable to provide an apparatus and method of multi-axis belt steering in a multi-stage image transfer printing system in order to avoid processing interruptions or delays, poor quality image registration and other shortcomings of the prior art.

### SUMMARY

According to aspects described herein, there is disclosed an apparatus for steering a belt in an image transfer assembly. The apparatus includes an image-bearing member, at least two image transfer nips and at least two belt steering rollers. The image-bearing member receives portions of an image, wherein the image-bearing member is supported by rollers. The image-bearing member moving in a process direction for conveying the received portions of the image. The at least two image transfer nips each transfer at least one portion of the image to the image-bearing member, wherein the image-bearing member extends continuously between the at least two image transfer nips. The at least two belt steering rollers are disposed remote from each other along the process direction of the image-bearing member. The at least two belt steering rollers can be idler rollers directly engaging the image-bearing member.

According to other aspects described herein, each of the at least two image transfer nips can have a corresponding different one of the at least two belt steering rollers for steering the image-bearing member through each respective image transfer nip. The image-bearing member can be a continuous loop belt. Also, the at least two belt steering rollers can be actuated to steer the image-bearing member at the same time. The image-bearing member can be an intermediate image-bearing member for receiving the image thereon. The image-bearing member can directly engage and conveys substrate media, where the substrate media receives the image thereon. Also, each of the image transfer nips can be disposed in a different one of at least two modular marking devices operatively connected in series to each other.

According to yet further aspects described herein, there is described a method of steering a belt in an image transfer assembly. The method includes detecting a first position of a first portion of a continuous loop image-bearing member at a first location, wherein the first location is a predetermined distance from a first image transfer nip. Also, detecting a second position of a second portion of the image-bearing member at a second location, wherein the second location is a predetermined distance from a second image transfer nip, the first and second image transfer nips being remote from one another. Then pivoting a first longitudinal axis of a first roller based on the detected first position and pivoting a second longitudinal axis of a second roller based on the detected second position, wherein the first and second rollers both support the image-bearing member. The first and second rollers being remote from one another and disposed on opposed sides of the first and second image transfer nips.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 is a schematic elevation view of an image transfer assembly in accordance with aspects of the disclosed technologies.

FIG. 2 is a schematic plan view of the image transfer assembly of FIG. 1, without the sheet inverter and the outer sheet path assemblies, in accordance with aspects of the disclosed technologies.

FIG. 3 is a schematic elevation view of another image transfer assembly in accordance with aspects of the disclosed technologies.

FIG. 4 is a schematic elevation view of another image transfer assembly, including an intermediate image-bearing member, in accordance with aspects of the disclosed technologies.

FIG. 5 is a schematic perspective view of an exemplary steering mechanism including a steering roller.

FIG. 6 is a schematic view of a modular assembly of printing systems in accordance with aspects of the disclosed technologies.

### DETAILED DESCRIPTION

Describing now in further detail these exemplary embodiments with reference to the Figures. A dynamic multi-axial belt steering apparatus and method is disclosed for more accurate image registration on a substrate media or an intermediate image-bearing member in a printing system. Thus, a portion of an exemplary image transfer assembly is illustrated herein, as well as an application of same to a modular assembly for printing.

As used herein, a “printer” or “printing system” refers to one or more devices used to generate “printouts” or a print outputting function, which refers to the reproduction of information on “substrate media” for any purpose. A “printer” or “printing system” as used herein encompasses any apparatus or portion thereof, such as a digital and/or analog copier, bookmaking machine, facsimile machine, multi-function machine, etc. which performs a print outputting function.

A printing system can use an “electrostatographic process” to generate printouts, which refers to forming and using electrostatic charged patterns to record and reproduce information, a “xerographic process”, which refers to the use of a resinous powder, such as toner, on an electrically charged plate, roller or belt and reproduce information, or other suitable processes for generating printouts, such as an ink jet process, a liquid ink process, a solid ink process, and the like. Also, such a printing system can print and/or handle either monochrome or color image data.

As used herein, “substrate media” refers to, for example, paper, transparencies, parchment, film, fabric, plastic, or other substrates on which information can be reproduced, preferably in the form of a sheet or web. A “target substrate media” refers to one or more particular substrate media intended to receive a transferred image. A “trial substrate media” refers to one or more preliminary sheets of substrate media passed through the printing system, or at least the transfer area of a printing system, prior to the target substrate media.

As used herein, the term “belt,” “transfer belt,” “transport belt,” “image-bearing belt” and “intermediate belt” refers to, for example, an elongated flexible web supported for movement along a process flow direction. For example, an image-bearing belt is capable of conveying an image in the form of toner or other marking material for transfer to a substrate media. Such formed toner or other marking material, prior to being deposited on a substrate media is referred to herein as a “image-forming marking material.” Another example includes a media transport belt, which preferably engages and/or carries a substrate media that receives marking material within a printing system. Such belts can be endless belts, looping around on themselves within the printing system in order to continuously operate. Accordingly, endless belts move in a process direction around a loop in which they circulate. A belt can engage a substrate media and/or carry marking material in the form of an image thereon over at least a portion of the loop. Image-bearing belts carry marking material in the form of a image-forming marking material. Image-bearing belts can include non-stretchable electrostatic or photoreceptor belts capable of accumulating toner thereon. An “image-bearing member” refers more generally to a belt, drum or other surface that can convey an image, as described more specifically for an image-bearing belt.

As used herein, “sensor” refers to a device that responds to a physical stimulus and transmits a resulting impulse for the measurement and/or operation of controls. Such sensors include those that use pressure, light, motion, heat, sound and magnetism. Also, each of such sensors as referred to herein can include one or more point sensors and/or array sensors for detecting and/or measuring characteristics of a belt, image or substrate media, such as speed, orientation, process or cross-process position, size or even thickness. Thus, reference herein to a “sensor” can include more than one sensor.

As used herein, the term “process direction” refer to a direction along a path associated with a process of printing or reproducing information on substrate media. The process direction is a flow path in which a belt moves as part of the system in order to convey an image and/or a substrate media from one location to another within the printing system. A “cross-process direction” is generally perpendicular to the process direction. Also, use of the terms “upstream” or “downstream” use the process direction as a reference, with the downstream direction being synonymous with the process direction and the upstream direction being opposite thereto. Further, use of the terms “lateral” or “lateral direction” are synonymous with the cross-process direction.

The presently disclosed technologies include an apparatus that uses multiple steering assemblies to control and maintain lateral alignment of a belt, particularly a image-bearing member. For example, the apparatus can include a printing apparatus that uses multiple belt steering systems to control and maintain lateral alignment of a image-bearing member. The position of the lateral edge of the belt can be measured by multiple belt edge sensors and then corrected by at least two belt steering rollers connected to corresponding belt steering mechanisms. The belt steering mechanisms tilt the rollers in order to adjust the lateral position of the belt at multiple locations. The steering mechanisms for the rollers can be controlled independently with the tilt of each steering roller being adjusted based on information obtained from corresponding belt edge sensors. Alternatively, the steering mechanisms for the rollers can be controlled dependently, with the tilt of each steering roller being adjusted based on information obtained from multiple sensors at multiple locations and further based on the predictable impact of the simultaneous movement of multiple steering rollers on the belt positioning.

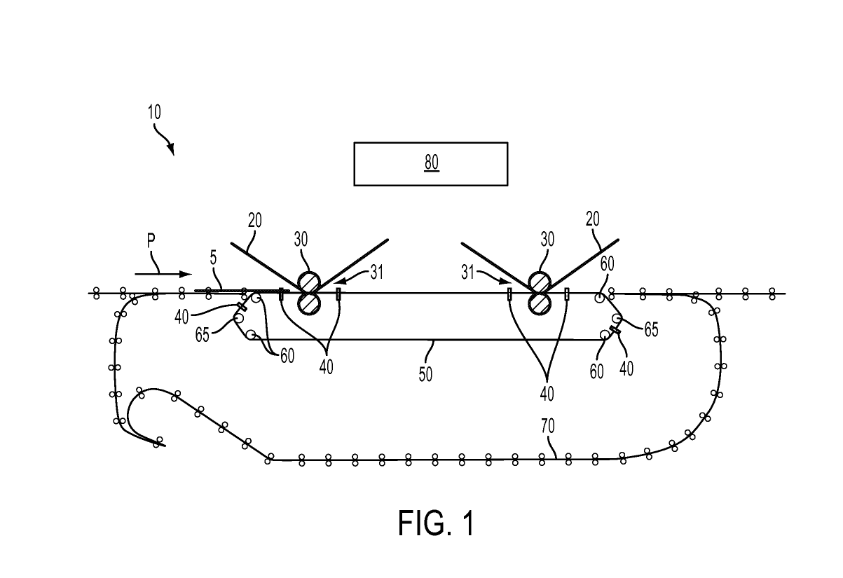

FIG. 1 is a schematic side elevation view of a portion of an image transfer assembly 10 that includes a media transport belt 50. The image transfer assembly 10 can be part of a printer, where the transport belt 50 conveys sheets 5 for receiving marking material, such as ink. In one aspect of the disclosed technologies, the image transfer assembly is of an electrostatographic or xerographic type, and includes image receptors in the form of multiple photoreceptor belts 20. The photoreceptor belts 20 each carry marking material, such as toner, developer particles, etc., of a given type to a nip assembly 30 that has a transfer nip 31, in order to transfer the marking material to a sheet of substrate media 5 conveyed by a media transport belt 50. The media transport belt 50 conveys the sheets along a primary media path P, but can re-circulate the sheets through other paths, including a duplex path 70 that includes an inverter and carries the sheet back across the media transport belt 50. In accordance with an aspect of the disclosed technologies herein, the media transport belt 50 is steered by rollers 65 supporting the belt 50. The rollers 65 are capable of tilting their axis of rotation, thus inducing the belt 50 to move toward one of the lateral sides of the roller providing less resistance. The position, at least laterally of the belt 50 is measured/detected by sensors 40 that transmit signals to a controller 80, which in-turn can tilt the rollers 65 in order to achieve the desired steering.

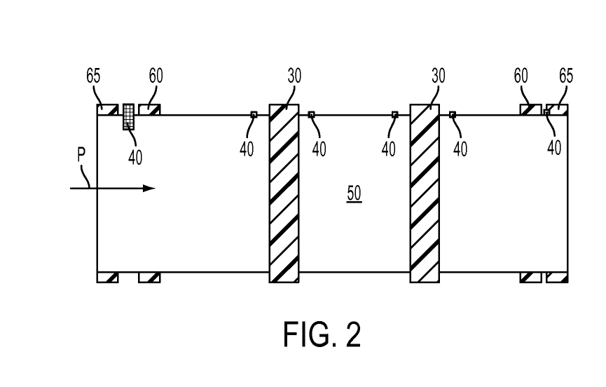

FIG. 2 is a plan view of the media transport belt 50 of FIG. 1, isolated with portions of the rollers 30, 60, 65 and sensors 40. In the orientation shown, the media transport belt 50 would normally operate by circulating in a clockwise direction. Thus, a sheet delivered to the media transport belt 50 in the process direction P would get conveyed from left to right, through the two nip assemblies 30.

In order to ensure lateral alignment of the endless belt 50 during operation (e.g., in the case of the printing apparatus described above or in the case of some other apparatus that incorporates the use of an endless belt), the apparatus disclosed herein can include multiple steering rollers 65. Each of these steering rollers 65 can be configured with a discrete corresponding steering mechanism. These steering mechanisms can be controlled, in response to sensor 40 measurements, by either discrete corresponding controllers or a single controller 80. It should be understood that the controller 80, or alternatively one or more other controllers (not shown), is operatively coupled to one or more of the drive rollers, sensors and/or steering rollers, as desired.

The transfer nips 31 are part of each nip assembly 30, which brings the photoreceptor belt 20 into engagement with, or at least in close proximity to, a media transport belt 50. Each transfer nip 31 defines a “transfer area,” which is defined by a region where marking material is directly transferred from one surface to another. The nip assembly 30 can include a driven roller and an opposed idler roller. The media transport belt 50 carries substrate media, in the form of a series of sheets, through each transfer nip 31, for each sheet 5 to receive the marking material from the photoreceptor belts 20. Alternatively, the nip assembly 30 can be other than an opposed single pair of rollers, as long as it forms a transfer area for the sheets 5 to receive the marking material. The transport belt 50 can also optionally make the sheets available for printing or further processing by a subsequent system (not shown). The transport belt 50 can include a single endless belt, as shown, looping back around through a portion of the sheet path P that passes through the transfer areas.

The sensors 40 detect the position and certain characteristics of the media image-bearing member 50, typically in the form of edge sensors. Such sensors 40 can also be used to detect a sheet 5 movement and/or position. Tracking or detecting belt movement is useful since individual sheets remain fairly well secured to the image-bearing member 50 and thus the sheet 5 movement generally corresponds well to the position of the image-bearing member 50. Thus, the position and/or other characteristics of a sheet 5 can be detected indirectly by sensing at least a portion of the transport belt 50. Also, as a further alternative, a combination of individual sheet and/or belt sensors can be employed as part of a sensor group. Further, it should be understood that sensors 40 need not be identical, so that the configuration and/or composition of individual sensors included could be varied. The sensors 40 can have the capability, in terms of response time and image resolution, to detect positional and other anomalies of transport belt movement, and output a “signal” related to measurements, particularly anomalies. This signal in turn can be used to steer the belt to a more desirable position. The sensor(s) 40 can be used to detect the position or speed of transport belt 50, by way of edge sensing or measuring some other portion of the transport belt 50. The sensors 40 include sensors disposed on opposed sides, in the process direction, of the marking engine and particularly the transfer area, with at least one sensor 40 on the upstream side of a transfer area and another on the downstream side.

With sensors 40 upstream and downstream of the transfer areas, the sensors can detect any movement and skew of the substrate media 5 or the belt 50 in or across the transfer area. Because the image is transferred onto the photoreceptor 20 when the substrate media is upstream of the transfer area (i.e., some time before the image is directly transferred to the sheet or intermediate image-bearing member), it is generally too late to use the detected sheet misalignment or belt drift information that occurred in the transfer area to correct image registration for that pass. However, the detected sheet misalignment or belt drift information from the transfer area when repeatable can be used to properly register the image in subsequent passes.

Additionally, although anomalies happening in the transfer area are difficult to correct with regard to the sheet being measured as it passes through the transfer area, some anomalies can be corrected for subsequent sheets before they reach the transfer area.

In accordance with an aspect of the disclosed technologies, the signal(s) output by one or more sensors can be collected, compiled and/or processed by what is here called a controller 80 or other processing device. The controller 80 then takes the signals received from the sensor(s) 40, in order to calculate what, if any, steering needs to be initiated for the transport belt 50. Thus, the controller 80 can influence the belt position by adjusting and/or altering the pitch of at least a portion of transport belt 50 and thereby change the belt's position.

The sensors 40 can include edge sensors, point sensors or virtually any sensing technique, in order to detect and/or measure transport belt position. It should be understood that a fewer or greater number of sensors could be used, limited only by the amount of information desired to be obtained by such sensors. Also, in a modular system signals from sensors 40 across the modules can be used collectively. Further, the sensors 40 can be positioned closer to or further from the transfer area than that shown in the illustrations. Positioning sensors 40 as close as possible to the transfer area can reflect more accurately movements occurring within or across the transfer area, but often this is limited by space and/or other components that normally reside in the same vicinity. Additionally, sensors 40 can be positioned adjacent to and in close proximity to the steering rollers 65.

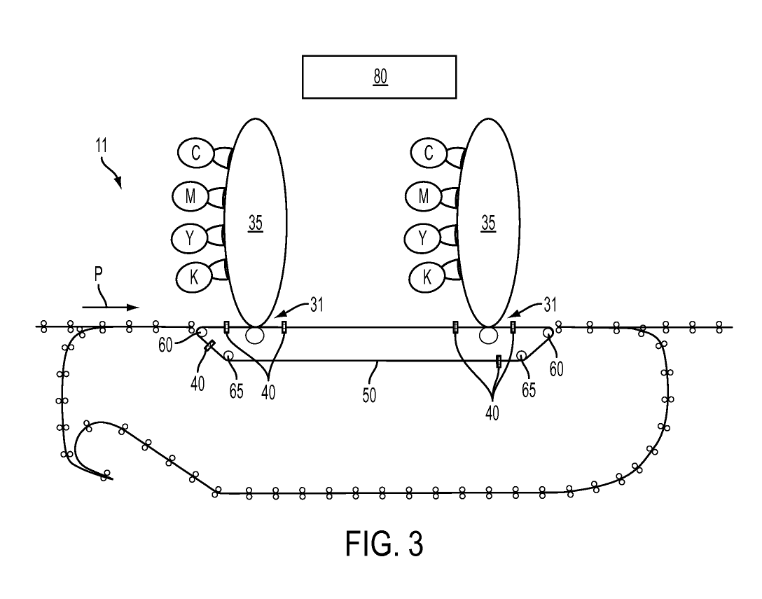

FIG. 3 is a schematic side elevation view of a portion of an alternative image transfer assembly 11 that also uses a media transport belt 50. The image transfer assembly 11 includes intermediate transfer assemblies 35 with a plurality of imaging stations positioned in series adjacent to the outer surface of an intermediate image-bearing member of the intermediate transfer assembly 35. The intermediate image-bearing member circulates through multiple imaging stations (C, M, Y, K) in order to assembly or compile a more complete image enabling full-color imaging thereon. The full-color image can then be transferred at each transfer nip 31 from the intermediate image-bearing member to a print medium (e.g., a sheet of paper) carried by the media transport belt 50. In this embodiment, the media transport belt 50 is shown to be supported by fewer rollers 60 and circulates in a somewhat different path. However, it should be understood that rollers can be configured to support the media transport belt 50 in almost any way and still remain within the scope of the present disclosure, as long as the belt 50 can be steered accordingly.

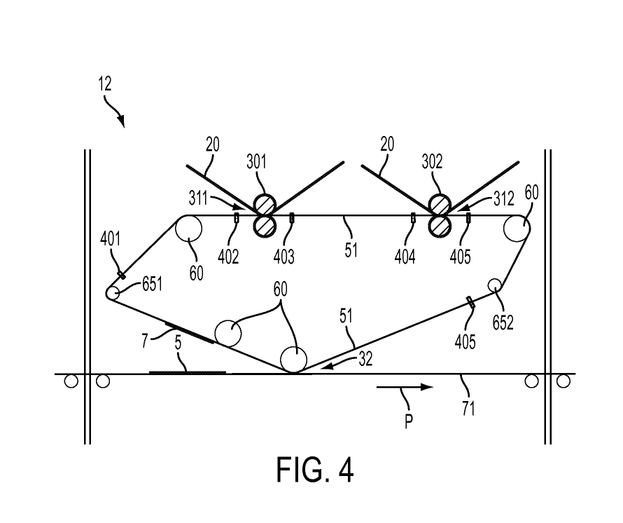

While the illustrated embodiments are directed to a substrate media image-bearing member 50, it should be understood that the disclosed technologies can be applied to an intermediate image-bearing member or virtually any media image-bearing member. FIG. 4. shows a simplified view of an exemplary image transfer assembly 12 that uses an intermediate image-bearing member 51. The intermediate image-bearing member 51 is supported by guide rollers 60, steering rollers 651, 652 and includes nip assemblies 301, 302 with its rollers. Additionally the image transfer assembly 12 includes more than one image transfer area corresponding to each of the nip assemblies 301, 302, as in the embodiment of FIG. 1. Further, the intermediate image-bearing member 51 is guided to a further transfer nip 32, where a image-forming marking material 7 carried by the intermediate image-bearing member 51 gets transferred to a sheet 5 carried by a further transport belt 71 in a process direction P. In FIG. 4, the sensors 401-406, drive rollers 651, 652, nip assemblies 301, 302 and nips 311, 312 are numbered differently for discussion purposes only. While each these elements can identical to the others of its kind in all respects other than their location within the system, they can also be different if it is desirable.

It should be understood that while this and the other embodiments show only two transfer areas (corresponding to nips 30, 301, 302) for receiving marking material onto the steered image-bearing member 50, 51, further stations could be provided at other positions along the image-bearing member 50, 51. The image-bearing member 50, 51 could be made longer or configured with smaller nip assemblies 30 in order to accommodate further transfer areas and the appropriate sensors 40-46.

During an image transfer operation, the image-bearing member 50, 51 passes through multiple transfer areas, corresponding to the transfer nip assemblies 30, in series in order to create/compile a full image on the belt surface. Thus, lateral alignment of each image-bearing member 50, 51 is critical to ensure proper image-on-print medium (IOP) registration and color-to-color registration. Here, lateral alignment refers to the positioning of the image-bearing member 50, 51 in the plane of the image-bearing member and normal to the process path P (into and out of the page as shown in FIGS. 1, 3 and 4). To achieve lateral alignment, many printing devices incorporate a belt steering system to reduce deviation of the belt from its desired transport path. Various types of belt steering systems are known in the art. Exemplary belt steering systems are discussed in detail in the following U.S. patents assigned to Xerox Corporation of Norwalk, Conn., and incorporated herein in their entirety by reference: U.S. Pat. No. 5,248,027 of Kluger, et al., issued on Sep. 28, 1993; U.S. Pat. No. 6,594,460 of Williams, et al, issued on Jul. 15, 2003; U.S. Pat. No. 5,225,877, of Wong, issued on Jul. 6, 1993; and U.S. Pat. No. 5,515,139 of Hou et al, issued on May 7, 1996.

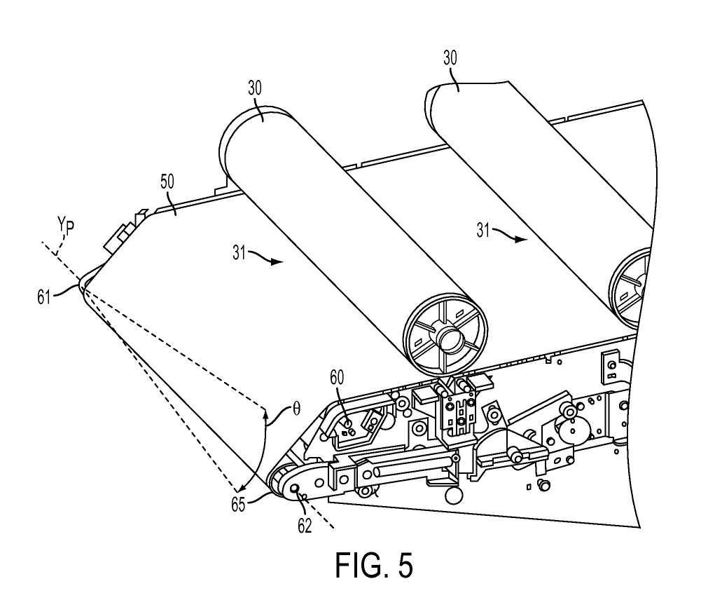

FIG. 5 shows an exemplary steering roller 65 for a belt steering systems. An aspect of the disclosed technologies includes at least two steering rollers 65. More particularly, the image transfer assemblies include one steering roller for each transfer area associated with the image-bearing member. Generally, a tilt mechanism corrects the lateral position of the intermediate image-bearing member 50. The steering roller 65 is freely rotatable about its axis Yₚ. Additionally, the roller 65 is configured so that it is capable of pivotal movement (i.e., tilting) about a soft axis that is out of plane with the image-bearing member 50. For example, the roller 65 can be mounted so that at least one end 62 can be moved away from the axis Yₚ (i.e., tilted, pivoted, etc.) in a given actuation direction, while the opposed end 61 remains at or near a pivot point. By moving (i.e., tilting, pivoting, etc.) the steering roller 65 as the belt 50 travels over it, the lateral position of the belt on the steering roller 65 can be adjusted. The advantage of having multiple steering rollers 65 is that belt edge positioning can be corrected for more than region of the belt 50.

Belt steering systems allow the steering roller 65 to correct for lateral belt skew. However, in contemporary systems the correction is made relative to only one location by only one steering roller 65 and is typically made based on information from only one sensor 40 positioned at a location near the steering roller 65. Therefore, such belt steering systems are capable of maintaining the desired lateral position of the edge of the belt, but only at the one measured location. However, as a function of the increased length of the image-bearing member 50 and the presence of other disturbances (e.g., disturbances caused by the sheet 5 passing through the transfer area), the lateral position of the image-bearing member 50 at other locations along the belt circumference may be skewed and may cause IOP registration errors or color-to-color registration errors.

In accordance with aspects of the disclosed technologies, the position of the lateral edge of the image-bearing member is measured by multiple belt edge sensors 40 and then corrected by at least two steering rollers 65 connected to corresponding belt steering mechanisms. The steering mechanisms for the plurality of steering rollers 65 can be controlled independently or dependently. Either way, the tilt of each steering roller 65 is based on information obtain from multiple sensors at multiple locations and further based on the predictable impact of the simultaneous movement of both rollers on belt positioning. Dependently controlled steering rollers 65 would have their actions coordinated to work together at achieving better belt positioning. The plurality of steering rollers 65 can be located at different positions with respect to the image-bearing member 50, 51. It is, however, generally desirable in the case of soft axis steering to have the steering roller axis pivot in a plane parallel to a midpoint of the steered belt wrap angle. Thus, steering rollers are generally located at a position where there is a large wrap around a given steering roller. Thus in FIG. 1, rollers 65 would be more desirably located to be steering rollers than rollers 60. However, it is also desirable to maintain the top of the image-bearing member 50 flat and thus avoid using the top rollers 60, as shown in FIG. 3, as the steering rollers.

The moveable end 62 of the steering roller 65 can be operatively connected to an actuator (e.g., a cam-follower system) capable of moving the movable end 62 in a given actuation direction. In this way, the steering roller 65 tilts (i.e., pivots, moves, etc.)

creating an angle θ with respect to the original roller axis Yₚ. Thus, in the orientation shown in FIG. 5, when the steering roller 65 is pivoted upwardly, the belt 50 will tend to walk toward the stationary pivot end 61 and when the steering roller 65 is pivoted downwardly, the belt 50 will tend to walk toward the moveable end 62.

Suitable steering mechanisms can comprise, for example, cam-follower systems. In such a system, rotation of a cam is controlled by a stepper motor. As the cam rotates, it engages a follower plate attached to a steering link. Next, the steering link moves the steering roller 65 such that it pivots about the pivot end 61 within the pivot angle range θ. A similar cam-follower system is disclosed in detail in U.S. Pat. No. 5,248,027, incorporated herein by reference above. Alternatively, other suitable tilt mechanisms can be employed, for example, solenoid-spring systems, as disclosed in detail in U.S. Pat. No. 5,225,877, also incorporated by reference above.

In order to maintain lateral alignment of the belt 50, 51 as it travels in a process direction P over the rollers 60, 65, one or more controllers 80 are used to control the movement (i.e., the tilting or pivoting) of a first steering roller 65 with respect to its pivot point as well as to control movement (i.e., the tilting or pivoting) of the second steering roller 65 with respect to its pivot point. It should be understood that were more than one controller 80 is used, the steering can be coordinated between them in order to achieve a more effective steering. Alternatively, multiple controllers could work independently. Also, information form a controller operating an upstream steering system can be used to feed-forward information to a downstream steering system.

The relationship of the position of the sensors 40 to the steering mechanisms is correlated to the level of steering control achieved by the system. This positional relationship will be discussed with reference to FIG. 4, which uses different numbering for some of the repeating elements, (e.g., the nip assemblies, nips, sensors and steering rollers), but should be understood to apply to all the disclosed embodiments. A first sensor 401 can be positioned adjacent to the first steering roller 651 on one side of the transfer nips 311, 312 and a second sensor 405 can be positioned adjacent a second steering roller 652 on an opposed side of the transfer nips 311, 312. It should be understood that use of the expression “first” or “second” herein is for distinguishing purposes only and is not intended to order or rank the elements. The first sensor 401 can determine (i.e., sense, measure, etc.) the position of a lateral edge of the belt 51 at the first sensor location (i.e., can determine a first lateral position of the belt). The first sensor 401 can communicate the first lateral position to a controller. The controller can then compare the first lateral position to a desired position for the lateral edge of the belt 51 at that first location. Then, the controller can determine a first pivot angle θ₁ for moving (i.e., tilting or pivoting) the first steering roller 651 in order to return the belt 51 and, more particularly, to return the lateral edge of the belt at the first location to the desired position. Similarly, a second sensor 405 can determine (i.e., sense, measure, etc.) the position of the lateral edge of the belt 51 at a second location adjacent to the second steering roller 652 (i.e., can determine a second lateral position of the belt). The second sensor 652 can also communicate the second lateral position to a controller. The controller can compare the second lateral position to the desired position for lateral edge of the belt 51 at that second location. Then, the controller can determine a second pivot angle θ₂ for moving (i.e., tilting or pivoting) the second steering roller in order to return the lateral edge of the belt at the second location to the desired position. The same methods can be applied in all the disclosed embodiments herein.

It should be understood that either a single controller 80 or discrete controllers (i.e., a first controller for controlling tilt of the first steering roller 651 and a second controller for controlling tilt of the second steering roller 652 can be used to compare the measured first and second lateral positions to the desired positions and to determine the required pivot angles. Such processes can be performed independently. In other words, the determined pivot angle θ₁ for the first steering roller 651 need not be dependent on the determined pivot angle θ₂ for the second steering roller 652 or vice versa.

Once the controller(s) determine(s) the required pivot angles for the first and second steering rollers 651, 652, the corresponding first and second actuators can be controlled accordingly in order to move (i.e., tilt, pivot, etc.) the first and second moveable ends to the determined first and second pivot angles, respectively, and, thereby to adjust belt positioning. Consequently, a first lateral position of the belt 51 at a first location and the second lateral position of the belt 51 at the second location are independently adjusted. The nip assemblies 301, 302 for the multiple imaging stations effectively isolate any edge position corrections made by the steering rollers 651, 652. That is, since there is a normal load applied to the belt 51 at each imaging station location by the force of the nip rollers, including the photoreceptor belt 20 with the media image-bearing member 51, the lateral motion of the media image-bearing member 51 will generally be dampened. This would cause the lateral motion of the belt from the first steering roller 651 to the second steering roll 120 to transfer more slowly than it would otherwise, and improve the chances of developing two independent steering controllers that do not conflict with each other.

Alternatively, a further plurality of sensors 402-404 can determine (i.e., measure, sense, etc.) the positions of the lateral edge of the belt 51 at multiple or different locations. For example, a first sensor 402 can determine a first lateral position of the edge of the belt 51 at a first location adjacent to the first nip 311 and a second sensor 404 can determine a second lateral position of the edge of the belt 51 at a second location adjacent to the second nip 312. In this way, the determined first and second lateral positions correspond to the belt just before entering each of the nip assemblies. As yet a further alternative the additional sensors 403, 404 can determine additional lateral position information for the edge of the belt 51. Using such additional sensors 403, 404 could give a better indication of the belt position across the image transfer areas between the corresponding pairs of sensors 402/403, 404/405.

As a further alternative, the various sensors 401-405 can each be used to communicate lateral positions to a controller. In this way, the controller can compare the positions at the multiple locations as desired for making adjustment at these multiple locations. Then, in order to return the belt 51 and, more particularly, the lateral edge of the belt 51 at these multiple locations to the desired positions, the controller can determine a first pivot angle for the first steering roller 651 and a second pivot angle for the second steering roller 652. This determination can be made by the controller based on the predictable impact of movement of both the first steering roller 651 and the second steering roller 652 on belt edge positioning. That is, correcting the position of the belt edge at one location by moving one steering roller may have a predictable impact on the positioning of the belt edge at another location. Thus, the best pivot angles for moving the first and second steering rollers 651, 652 in order to achieve the desired lateral belt alignment can be determined based on knowledge of the relationship between the two steering rollers 651, 652 and how their movement in combination will impact belt positioning. Once the controller determines the required pivot angles for the first and second steering rollers 651, 652, the controller can adjust the corresponding first and second actuators accordingly in order to move (i.e., tilt, pivot, etc.) the first and second moveable ends to the first and second pivot angles, respectively, and, thereby to adjust belt positioning. Consequently, in this embodiment, the first lateral position of the belt 51 at the first location and the second lateral position of the belt 51 at the second location are dependently adjusted.

FIG. 5 is a schematic perspective view of an exemplary steering mechanism for an endless belt 50, which can be supported, at least in part, by multiple steering rollers 65. That is, the inner surface of the endless belt 50 contacts at least a portion of the outer surface of each steering roller 65 and other support rollers 60. The steering rollers 65 can comprise at least a first steering roller and a second steering roller (not shown) can be located at different positions with respect to the belt and the nip assemblies 30, particularly the transfer nips 31. The first or second steering roller 65 can have an outer surface in contact with the inner belt surface. The steering roller can further have a pivotal axle Yₚ. For example, one end 61 can be relatively fixed while the opposed end 62 moves, allowing the roller axle to pivot. The moveable end 62, or desired portion of the roller axle can be operatively connected to an actuator (e.g., a cam-follower system) capable of pivoting the steering roller 65 in a given actuation direction. In this way, the axle tilts a tilt angle θ and, thereby, the steering roller 65 pivots (i.e., moves) with respect to a pivot point at the fixed end 61. By tilting the steering roller 65 at a specific angle θ with respect to the pivot point 61, as the belt 50 travels over the steering roller 65, the lateral position of the belt 50 on the steering roller 65 can be selectively adjusted. Similarly, the second steering roller (not shown) can have a corresponding structure and function as the first steering roller, similarly contacting the inner belt surface. The second steering roller thus having its own pivotal axle and actuator. Just as with the first steering roller, by tilting the second steering roller at a specific angle with respect to its own pivot point as the belt travels over the second steering roller, the lateral position of the belt on the second steering roller can be selectively adjusted. Thus, in order to maintain lateral alignment of the belt as it travels in a given direction over the rollers, one or more controllers are used to control the movement (i.e., the tilting or pivoting) of the first steering roller with respect to its pivotal capability, as well as to control movement (i.e., the tilting or pivoting) of the second steering roller with respect to its pivotal capability. It should be understood that the first and second steering rollers can be controlled independently or dependently with respect to one another.

Generally, the media transport belt 50, 51 is supported by rollers 60, 65, 651, 652 that are idler rollers which rotate freely. The media transport belt 50 will generally drive the rotational movement of such idler rollers. The media transport belt 50 itself is generally driven by driven rollers, such as drive rollers included in the nip assembly 30. Soft axis steering is preferably done by steering a belt through the use of rollers that are not directly driven (i.e., not drive rollers). A soft axis steering system of this kind tends to be less complicated than steering a driven roller and the overall belt tension over the full belt surface will not vary as much while steering. Hard axis steering, which tiled a steering roller in or out of the plane of the belt, can introduce wrinkling on the belt surface and often requires very small movements and large forces. Although hard axis steering can be less favorable, it is a viable option and can be used in accordance with aspects of the disclosed technologies. In particular, as drive rollers generally have larger “wraps” around the roller, they can be desirable for steering.

In order to optimize space within the apparatus of embodiments described above, one of the steering rollers can further be configured as a drive roller. Rotation of the steering/drive roller in a given direction (e.g., a counter clockwise direction or, alternatively, a clockwise direction) will cause the belt 50, 51 to travel in that same direction. In order to configure the first steering roller as a drive roller, a drive motor (not shown) must be operatively connected thereto as is known in the art.

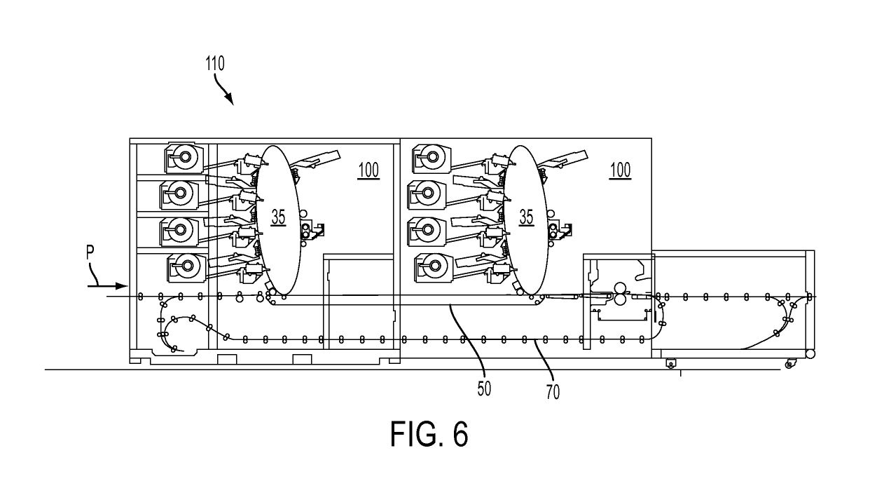

It should be understood that alternatively, the transport belt, as shown in FIG. 6, could include a belt that extends along and between more than one printing system 10, such as a plurality of modular printing systems. FIG. 6 is a schematic side elevation view of a modular printing assembly 110 of printing systems, including more than one image transfer assembly 100 arranged in series. In possible implementations, a central processor (not shown) is provided, for governing and coordinating a plurality of printing subsystems, including individual modules 100 of a modular system. The central processor can interact and coordinate individual controllers within each module 100, where each module 100 by itself could be considered printing system.

Correction of positional anomalies within or between a series of modules 100 along a print path P can be divided between the controllers associated with each module or a central controller (not shown) controlling the steering across the print path of those modules. In one implementation, anomalies within a predetermined spatial range can be corrected internally within less than all the modules to be handled by an internal controller therein. For example, a single module in response to a detected anomaly can perform a correction, entirely apart from the other modules. Larger or cumulative spatial anomalies can be handled by the central controller. Another arrangement could provide for the central controller to detect recurrent patterns of positional errors and command individual modules accordingly.

The illustrated embodiments relate to so-called “digital” printing systems, in that the marking engine, whether electrostatographic, ink-jet, or some other printing technology, ultimately relying on input image data in digital form. Alternatively, other types of printing system could be used, particularly in a modular assembly. Even modules using non-digital technology could be designed to be responsive to image-bearing member correction based on anomalies detected by a sensing system.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims, as originally presented and as they may be amended, encompass variations, alternatives, modifications, improvements, equivalents, and substantial equivalents of the embodiments and teachings disclosed herein, including other marking technologies such ink jet printing and those that are presently unforeseen or unappreciated, and that, for example, may arise from applicants/patentees and others.

What is claimed is:

1. An apparatus for steering a belt in an image transfer assembly, the apparatus comprising:
a image-bearing belt for receiving portions of image-forming marking material, wherein the image-bearing belt is supported by rollers, the image-bearing belt moving in a process direction for conveying the received portions of the image-forming marking material;
at least two image transfer nips, wherein each image transfer nip transfers at least one portion of the image-forming marking material to the image-bearing belt, wherein the image-bearing belt extends continuously between the at least two image transfer nips;
at least two belt steering rollers disposed remote from each other along the process direction of the image-bearing belt, the at least two belt steering rollers being idler rollers directly engaging the image-bearing belt for changing a lateral position of at least a portion of the belt.

2. The apparatus of claim 1, wherein each of the at least two image transfer nips is associated with a corresponding different one of the at least two belt steering rollers for steering the image-bearing belt through each respective image transfer nip.

3. The apparatus of claim 1, wherein the image-bearing belt is a continuous loop belt.

4. The apparatus of claim 1, wherein the at least two belt steering rollers are actuated to steer the image-bearing belt at the same time.

5. The apparatus of claim 1, wherein the image-bearing belt is an intermediate belt for receiving the image-forming marking material thereon and subsequently transferring the image-forming marking material to another image-bearing member.

6. The apparatus of claim 1, wherein the image-bearing belt is a transport belt that directly engages and conveys substrate media, the substrate media receiving the image-forming marking material thereon.

7. The apparatus of claim 1, wherein each of the image transfer nips is disposed in a different one of at least two modular marking devices operatively connected in series to each other.

8. The apparatus of claim 1, further comprising:
at least two sensors for detecting a lateral position of the image-bearing belt, the at least two sensors including at least one first sensor and at least one second sensor, the at least one first sensor being disposed adjacent and closer to a first one of the at least two image transfer nips and the at least one second sensor being disposed adjacent and closer to a second one of the at least two image transfer nips.

9. The apparatus of claim 1, further comprising:
at least two sensors for detecting a lateral position of the image-bearing belt, each of the sensors disposed adjacent and closest to a different one of the at least two belt steering rollers.

10. The apparatus of claim 1, further comprising:
a plurality of sensors for detecting a lateral position of the image-bearing belt, at least one sensor being disposed adjacent each of the at least two image transfer nips and at least one sensor being disposed adjacent each of the at least two belt steering rollers.

11. A method of steering a belt in an image transfer assembly, the method comprising:
detecting a first position of a first portion of a continuous loop image-bearing belt at a first location, wherein the first location is a predetermined distance from a first image transfer nip;
detecting a second position of a second portion of the image-bearing belt at a second location, wherein the second location is a predetermined distance from a second image transfer nip, the first image transfer nip and the second image transfer nip being remote from one another;
changing the orientation of a first roller by pivoting a longitudinal axis of the first roller based on the detected first position; and
changing the orientation of a second roller by pivoting a longitudinal axis of the second roller based on the detected second position, wherein the first and second rollers both support the image-bearing belt, the first and second rollers being remote from one another, the first roller being disposed on an upstream side of the first and second image transfer nips and the second roller being disposed on a downstream side of the first and second image transfer nips.

12. A method of steering a belt in an image transfer assembly of claim 11, wherein the pivoting of each of the first roller and the second roller changes an angle of orientation of the axis relative to a planar extent of the image-bearing belt.

13. A method of steering a belt in an image transfer assembly of claim 11, wherein the first and second rollers are idler rollers.

14. A method of steering a belt in an image transfer assembly of claim 11, wherein the detected first location is disposed closer to the first transfer nip than to the first roller and the detected second location is disposed closer to the second transfer nip than to the second roller.

15. A method of steering a belt in an image transfer assembly of claim 11, wherein the detected first location is disposed closer to the first roller than to the first transfer nip and the detected second location is disposed closer to the second roller than to the second transfer nip.

16. A method of steering a belt in an image transfer assembly of claim 11, further comprising:
detecting a third position of a third portion of a continuous loop image-bearing belt at a third location, wherein the third position is used in conjunction with the first position in determining the change of orientation of the first roller.

17. A method of steering a belt in an image transfer assembly of claim 16, wherein the first and third locations are disposed on opposed sides of the first image transfer nip.

18. A method of steering a belt in an image transfer assembly of claim 11, wherein the first and second roller movements are coordinated for adjusting the belt.

19. A method of steering a belt in an image transfer assembly of claim 11, wherein the image-bearing belt is an intermediate belt for receiving image-forming marking material thereon and subsequently transferring the image-forming marking material to another image-bearing member.

20. A method of steering a belt in an image transfer assembly of claim 11, wherein the image-bearing belt is a transport belt that directly engages and conveys substrate media, the substrate media receiving image-forming marking material thereon.
